(19) United States
(12) Patent Application Publication
(10) Pub. No.: US 2008/0165925 A1
(43) Pub. Date: Jul. 10, 2008

(54) DOUBLE-FACETTED ILLUMINATION SYSTEM WITH ATTENUATOR ELEMENTS ON THE PUPIL FACET MIRROR

(75) Inventors: Wolfgang Singer, Aalen (DE); Joachim Hainz, Aalen (DE); Erich Schubert, Ellwagen (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 11/961,431

(22) Filed: Dec. 20, 2007

Related U.S. Application Data
(63) Continuation of application No. PCT/EP2006/005857, filed on Jun. 19, 2006.
(60) Provisional application No. 60/692,700, filed on Jun. 21, 2005.

(51) Int. Cl. G21K 5/00; G02B 13/14

(52) U.S. Cl. 378/34; 359/355

(57) ABSTRACT

The invention relates to an illumination system with a light source emitting radiation with a wavelength ≦193 nm, especially radiation in the EUV wavelength range. The invention comprises a first facetted optical element in a first plane with at least a first and second field raster element which receive the light of the light source and divide the same into a first and second bundle of light; a optical component comprising at least a second facetted optical element in a second plane with a first and second pupil raster element, with the first light bundle impinging upon the first pupil raster element and the second light bundle impinging upon the second pupil raster element, with an attenuator being arranged in or close to the second plane or a plane conjugated to the second plane at least in the first light bundle extending from the first field raster element to the first pupil raster element, wherein the optical component images the first and second field raster element into a field plane.

### CROSS REFERENCE TO RELATED APPLICATIONS

This application is a continuation application and claims benefit of International Patent Application Serial No. PCT/EP2006/005857, filed on Jun. 19, 2006, which claims benefit and priority under § 119 USC of U.S. provisional application 60/692,700, filed in the US Patent and Trademark Office on Jun. 21, 2005. The entire contents of these applications are incorporated herein in its entirety.

### FIELD OF THE INVENTION

The invention relates to an illumination system with a light source, with the light source emitting radiation with wavelengths ≦193 nm, especially radiation in the EUV wavelength range. The illumination system is a double facetted illumination system. In a double facetted illumination system, the illumination system comprises at least two facetted optical elements, a first facetted optical element and a second facetted optical element. The facetted optical elements comprise a plurality of facets which are also known as raster elements. In a double facetted illumination system the facets of the first optical element are imaged by one or more optical elements into a field plane illuminating a field in the field plane. The illumination of such a double facetted illumination system is a Koehler illumination.

The first facetted optical element comprises at least a first and a second field raster element which receives the light bundle of the light source and divides the same into a first and second light bundle. The second optical component comprises at least a first and a second pupil raster element. A first light bundle extends between the first field raster element and the first pupil raster element and a second light bundle between the second field raster element and the second pupil raster element.

### STATE OF THE ART

Illumination systems for microlithography with wavelengths ≧193 nm are known from a large number of publications. The illumination systems can be part of a microlithography projection exposure apparatus.

In order to enable the reduction of the structural width of electronic components especially into the sub-μm range it is advantageous to reduce the wavelengths of the employed light. The use of light with wavelengths ≦193 nm is appropriate, especially lithography with soft X-rays, the so-called EUV lithography.

In EUV lithography, wavelengths of 11 to 14 nm are currently discussed, especially wavelengths of 13.5 nm. The image quality in EUV lithography is determined by the projection objective on the one hand, and by the illumination system on the other hand. The illumination system shall illuminate a field or ring field as uniform as possible in a field plane in which a structure-bearing mask, the so-called reticle, can be arranged. With the help of the projection objective, a field in a field plane is projected to an image plane which is also known as wafer plane. A light-sensitive object such as a wafer is arranged in the image plane.

In the case of systems which work with EUV light, the optical elements are arranged as reflective optical elements. A illumination system which only employs reflective optical elements is a so called catoptric illumination system. The shape of the field in the field plane of an EUV illumination system is typically that of an annular field.

Microlithography projection exposure systems in which the illumination systems in accordance with the invention are used are usually operated in the so-called scanning mode. Illumination systems for EUV lithography and microlithography projection exposure systems with such illumination systems are known from U.S. Pat. No. 6,452,661, U.S. Pat. No. 6,198,793 or U.S. Pat. No. 6,438,199. The previously mentioned EUV illumination systems comprise so-called honeycomb condensers for setting the etendue and for achieving a homogeneous illumination of the field in the field plane. As already described above, the honeycomb condensers usually comprise two facetted optical elements, a first facetted optical element and a second facetted optical element with a plurality of raster elements. In catoptric illumination systems the first facetted optical element comprises a plurality of field mirror facets and the second optical element comprises a plurality of pupil mirror facets.

WO 2005/015315 discloses a double-facetted illumination system, in which attenuators, especially filter elements, are arranged in or close to a plane conjugated to the field plane for the purpose of improving uniformity in the illumination of a field in a field plane. The filter elements are associated according to WO 2005/015314 to the individual facets of the first facetted element. This allows influencing the light intensity in each individual light channel which is associated with a facet of the first facetted element.

U.S. Pat. No. 6,225,027 shows a illumination system for EUV-microlithography comprising a light source and a collector mirror. The collector mirror is divided into 2-12 mirror segments. Such a low number of mirror segments causes high uniformity errors in the field plane. Moreover the illumination system according to U.S. Pat. No. 6,225,027 shows a illumination system with a critical illumination in a tangential direction in a field plane. A disadvantage of a critical illumination in a direction in a field plane is that the light source is imaged in the field plane and therefore e.g. intensity fluctuations of the light source directly influence the uniformity in the field.

### SUMMARY OF THE INVENTION

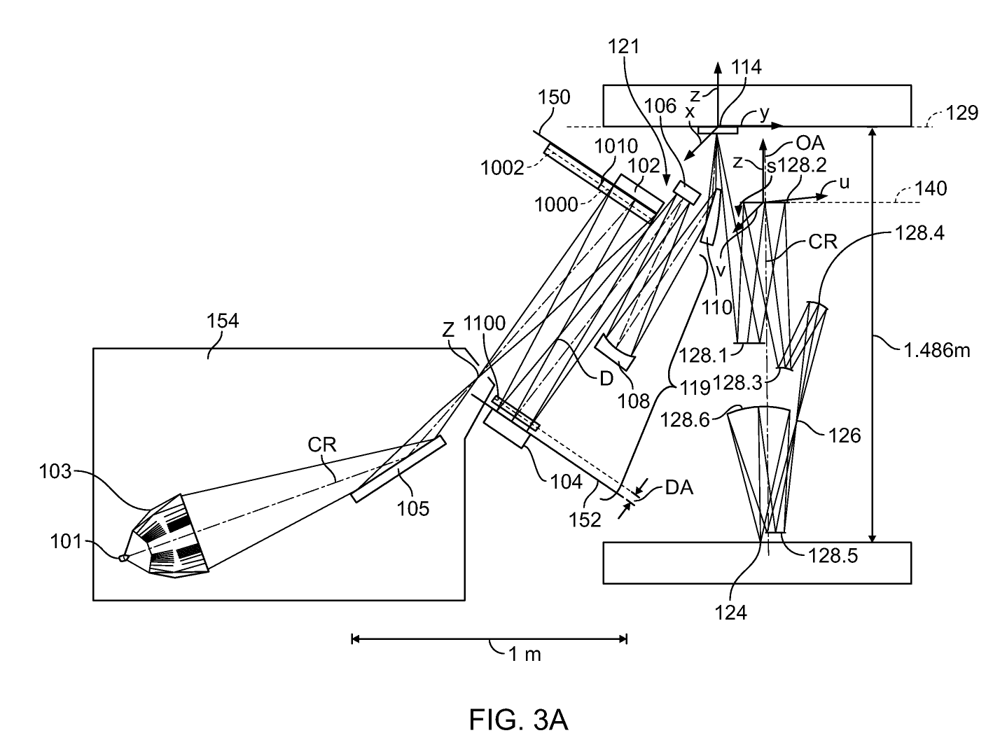

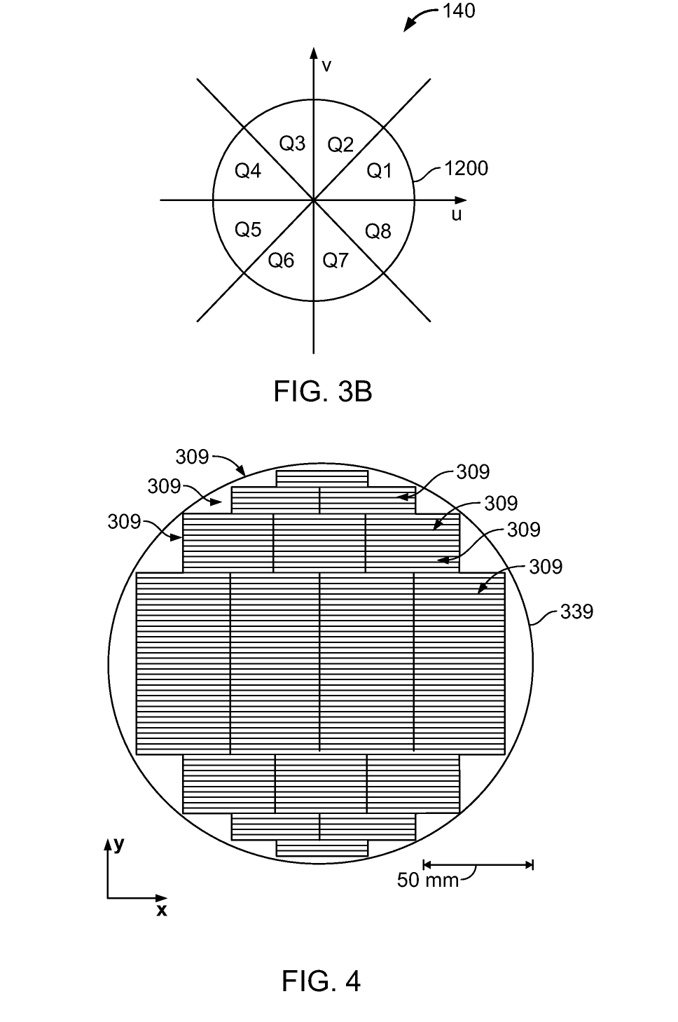

The disadvantageous aspect in the previously described systems according to the state of the art was that large ellipticity errors can occur in the exit pupil of the illumination system which coincides with the entrance pupil of the projection objective as a result of an inhomogeneous illumination of the first optical element with first raster elements. This is especially the case when strongly elliptical sources are used as a light source, which sources lead to the consequence that the image of such light sources (i.e. the so-called secondary light sources) which are projected onto or close to the second facetted optical element with pupil raster elements vary strongly in respect of size and energy content. This variation leads to an inhomogeneous filling of the exit pupil of the illumination system which coincides with the entrance pupil of the projection objective. The inhomogeneous filling of the exit pupil leads to the aforementioned ellipticity errors. In the present application, ellipticity shall be understood as the weighting of the energy distribution in the pupil. When the energy is evenly distributed in the exit pupil over the angular range, the ellipticity has a value of 1. The ellipticity error designates the deviation of the ellipticity from the ideal value of even distribution, namely the value of 1. Ellipticity is explained in closer detail in FIG. 3b in the description of the figures.

It is the object of the present invention to overcome the disadvantages of the state of the art, especially by providing an illumination system for wavelengths ≦193 nm which is characterized by low ellipticity and telecentricity errors.

This object is achieved in accordance with the invention by an illumination system with a light source which emits radiation with a wavelength ≦193 nm, with the illumination system comprising a first facetted optical element having at least a field facet or field raster element in a first plane and a optical component having at least a second facetted element in a second plane having at least a pupil facet or pupil raster element, with at least one pupil facet or pupil raster element of the second facetted optical component being vignetted in full or in part by an attenuator which can be configured as a stop or as a filter, with the attenuator being arranged in or close to the second plane or in or close to a plane conjugated to the second plane and wherein the field facet is imaged by the optical component into a field plane.

In order to enhance the uniformity of a field to be illuminated in the field plane, the first facetted optical element comprises more than 20 field facets or field raster elements, preferably more than 40 field facets, more preferably more than 60 field facets, most preferably more than 80 field facets, almost preferably more than 100 field facets, preferred more than 120 field facets, most preferred more than 150 field facets, almost preferred more than 300 field facets.

The second facetted optical element comprises the same number of pupil facets or pupil raster elements as the first facetted optical element. In such a case each field facet is associated to one pupil facet. In a preferred embodiment the number of pupil facets is higher than the number of field facets. Such a system then e.g. allows for changing the pupil illumination by changing the association of field facets to pupil facets.

In a preferred embodiment the second facetted optical element comprises more than 20 pupil facets, preferably more than 40 pupil facets, more preferably more than 60 pupil facets, most preferably more than 80 pupil facets, almost preferably more than 100 pupil facets, preferred more than 120 pupil facets, most preferred more than 150 pupil facets, almost preferred more than 300 pupil facets.

Preferably the illumination system comprises in a light path from the light source to the first facetted optical element a collector for collecting radiation from the light source and illuminating an area on the first facetted optical element. Preferably such an illuminated area on the first optical element is a ring shaped area. By placing a collector in the light path before the first facetted optical element, the light efficiency of the illumination system can be enhanced. Furthermore in such a system the collector is heated by the light source instead of a facetted optical element as shown e.g. in U.S. Pat. No. 6,225,027. Most preferred is a nested grazing incidence collector. A nested grazing incidence collector has the advantage, that the thermal load can be absorbed without diminishing the optical performance of the collector in contrast e.g. to a normal incidence optical element. Such a collector is described in US 2004/0065817A1. The content of US 2004/0065817A1 is enclosed herein.

Preferable by the inventive illumination system the scan-integrated ellipticity has a variation depending on the X-position, i.e. the field height in a field to be illuminated, which is smaller than +/−10%, especially smaller than +/−5%. Moreover, the system is preferably characterized by a low telecentricity error which does not exceed an error of +/−0.5 mrad preferably depending on the position in the field, i.e. the field height.

In a preferred embodiment, the stop is arranged as an annular stop.

Possible configurations are also rectangular or trapezoid stops.

As a result of the annular stops which substantially correspond to the shape of the facets of the second facetted element, the individual light bundles can be vignetted partially. The facets of the second facetted element are also known as pupil facets. The partial or complete vignetting leads to the consequence that a tertiary light source which is also known as sub-pupil can be vignetted in part or in full in the exit pupil plane of the illumination system. This means that these sub-pupils contribute very little or nothing at all to the distribution of illumination in the exit pupil.

In order to provide the best possible stable construction it is advantageous when the stops which provide a partial vignetting of the individual pupil facets or pupil raster elements are made integrally, e.g. in the form of a stop wheel. Such a stop wheel comprises in one embodiment of the invention a plurality of circular openings.

It is provided for in an alternative embodiment of the invention that a plurality of wires are used for vignetting pupil facets, which wires can be configured in such a way for vignetting the pupil facets that the vignetting can be varied.

As an alternative to stops consisting of wires, ring field stops or rectangular stops can be used.

For the purpose of variable vignetting individual pupil facets, rectangular stops can be configured in such a way that they are swivelable or displaceable about an axis, so that depending on the position of the rectangular stop different areas of a cross section of a light bundle impinging upon the pupil raster elements can be vignetted. This allows partly vignetting individual pupil facets.

In accordance with the invention, the stop or the filter element is arranged close to the second facetted element in the beam path of the illumination system from the light source to the plane to be illuminated, the so-called field plane, in which the projected structured mask is arranged. Close shall be understood in the present application as a physical distance along the light path from the first facetted optical component to the second facetted optical component which is less than 10% of the physical distance between the first facetted optical element and the second facetted optical element.

In an alternative embodiment, the attenuator, i.e. the stop or filter, is arranged in a plane which is conjugated to the plane in which the second facetted optical element is arranged.

The optical elements are provided with a reflective configuration in illumination systems which work with wavelengths in the range of EUV radiation. This relates especially to the field facets or field raster elements of the first facetted optical element and pupil facets or pupil raster elements of the second facetted optical element.

In order to obtain an illumination system which is characterized by a uniform illumination of the field in the field plane it can be provided that a further attenuator is positioned close to the first plane in which the first optical element is arranged. This can occur for example in the light path from the light source to the first facetted optical element, as described in WO2005/05314, after the light source and before the first facetted element, preferably close to the first facetted optical element.

In an especially preferred embodiment it can be provided that the shape of the pupil facets of the second facetted optical element substantially corresponds to the shape of the respective secondary light source configured by the first facetted optical element.

The efficiency of the system can thus be increased considerably.

In a first embodiment of the invention it can be provided that the field facets substantially have the shape of the field of the field plane, i.e. in the case of a ring-shaped field they are also provided with a ring-shaped configuration.

In a second embodiment of the invention, the field facets or the field raster elements substantially have a rectangular shape as well as components for shaping the field.

In addition to the illumination system, the invention also provides a projection exposure system for microlithography with wavelengths ≦193 nm, comprising an illumination system in accordance with the invention for illuminating a field in a field plane and a projection objective for projecting an object, e.g. a reticle, arranged in the field of the field plane to an image in an image plane.

A light-sensitive object is usually arranged in the image plane of the projection objective, which object can be structured by illumination with light. This light-sensitive object arranged in the image plane is the basis for the production of micro-structured components. In this respect the invention also provides a method for producing microelectronic components, e.g. semi-conductor chips, with the help of the projection exposure apparatus in accordance with the invention by illuminating the light sensitive object and developing the same.

### DESCRIPTION OF THE INVENTION

The invention will be explained below by way of examples by reference to the enclosed drawings, wherein:

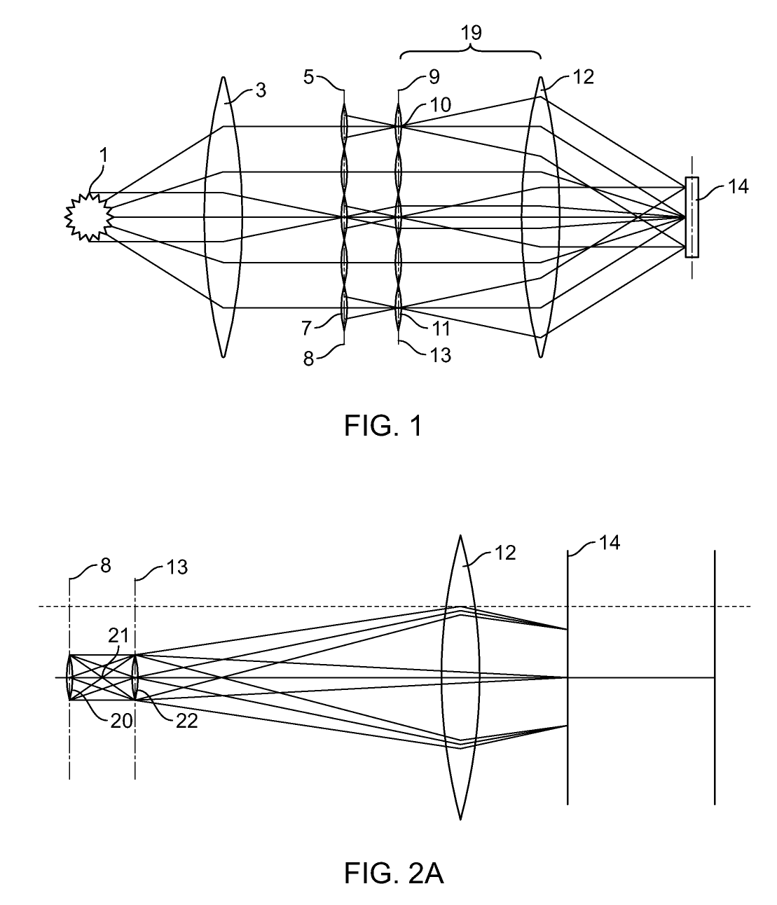

FIG. 1 shows an elementary diagram of a double-facetted illumination system;

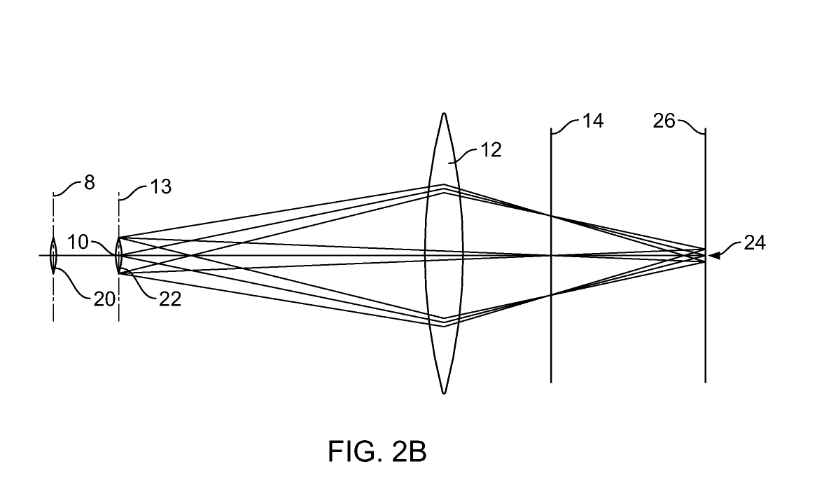

FIG. 2A shows the beam path of a double-facetted illumination system from a light source up to the field plane;

FIG. 2B shows the beam path of a double-facetted illumination system from a light source up to the exit pupil plane;

FIG. 3a shows the principal configuration of an illumination system;

FIG. 3b shows the exit pupil in the exit pupil plane;

FIG. 4 shows a first facetted optical element with field raster elements;

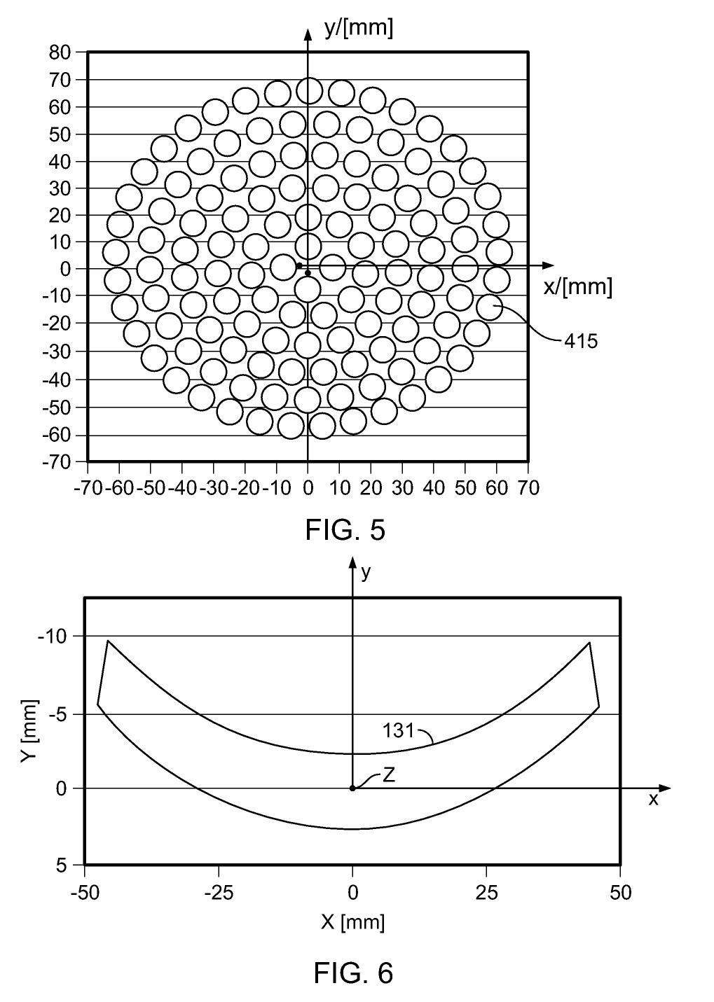

FIG. 5 shows a second facetted optical element with pupil facets;

FIG. 6 shows an illuminated ring field in the field plane of the illumination system;

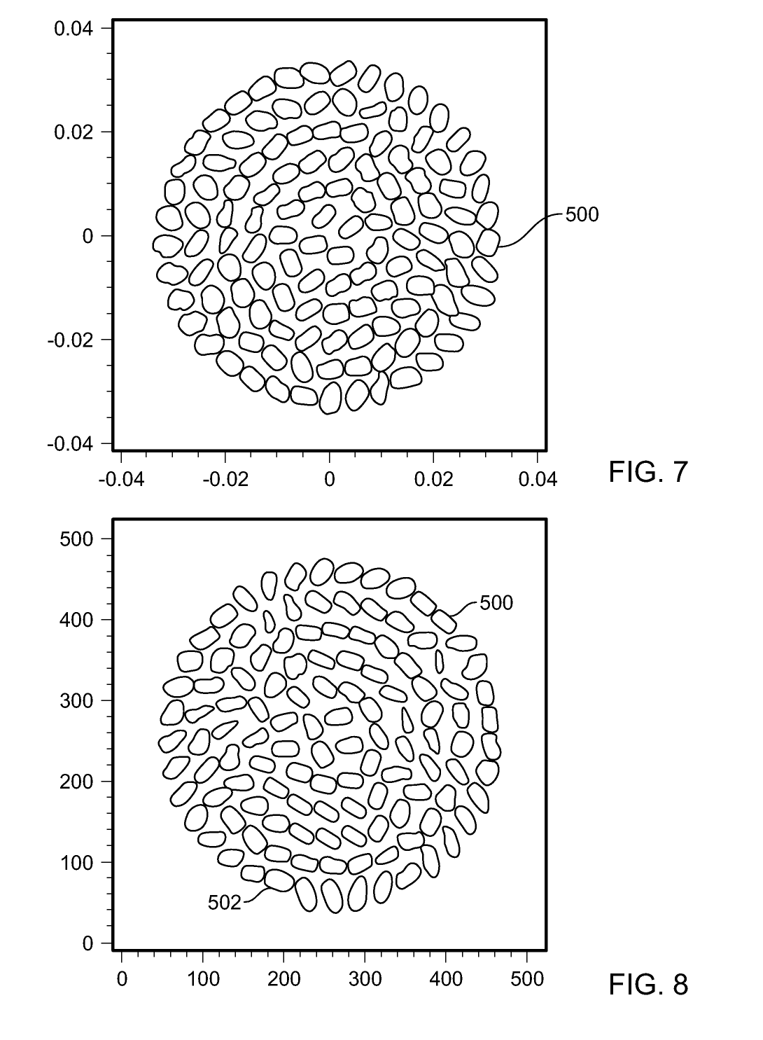

FIG. 7 shows a pupil illumination in the exit pupil plane without correction by an attenuator;

FIG. 8 shows a pupil illumination in the exit pupil plane with correction by an attenuator;

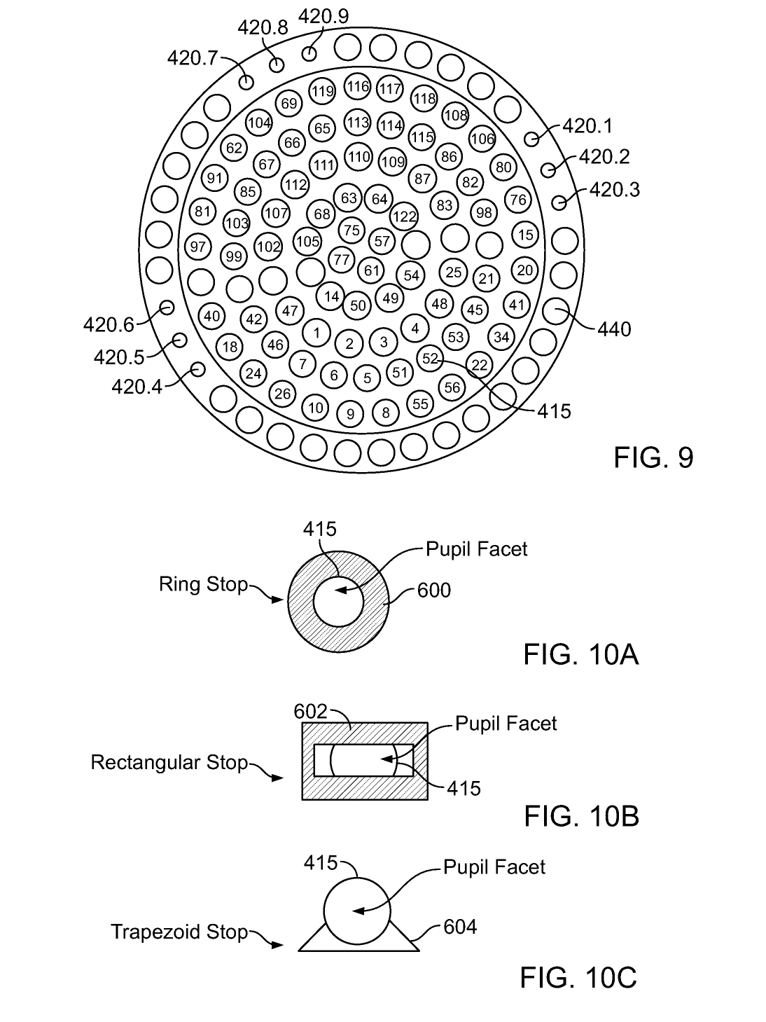

FIG. 9 shows a second facetted optical element with a stop wheel arranged close by;

FIGS. 10a to 10c show different types of stops;

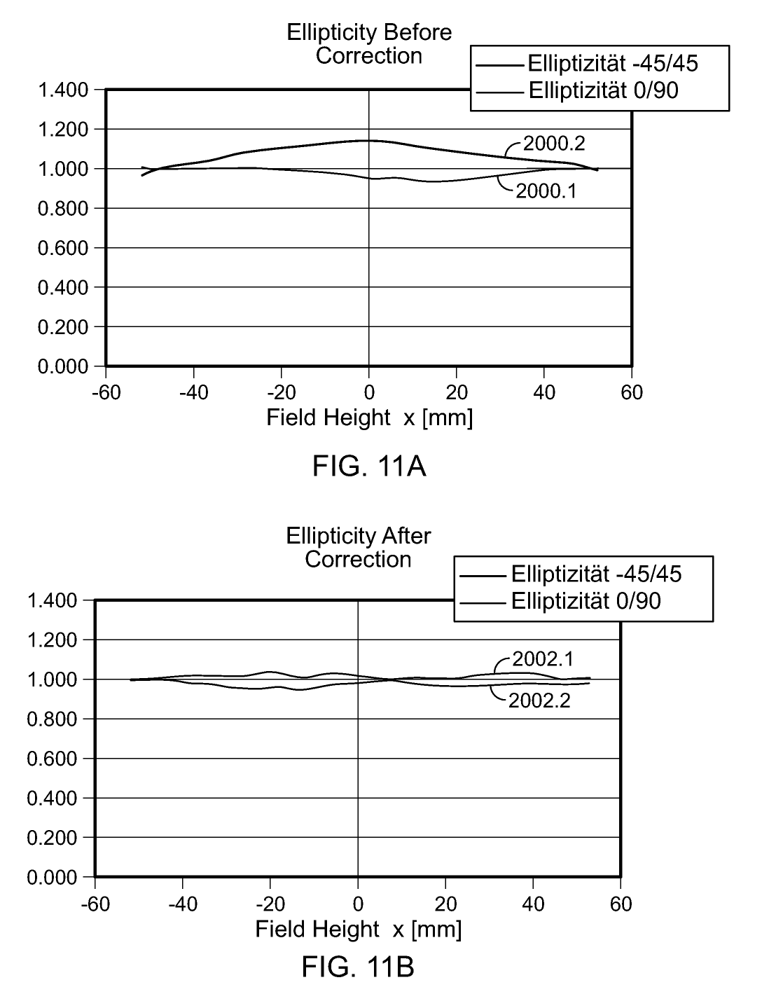

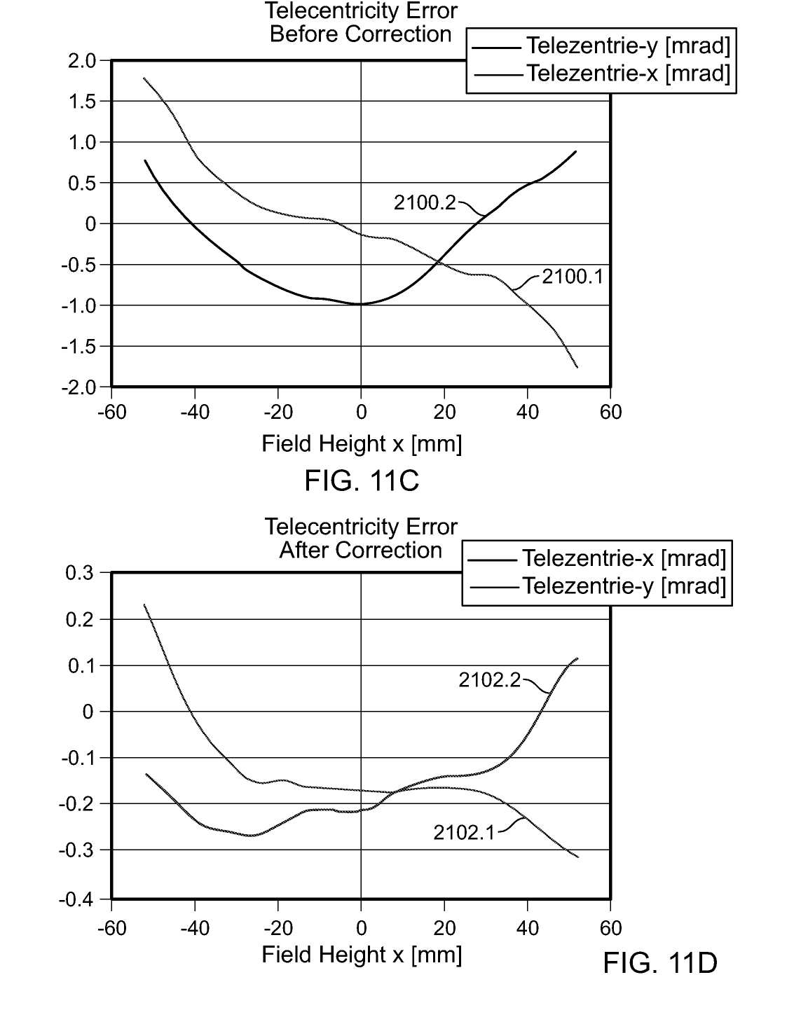

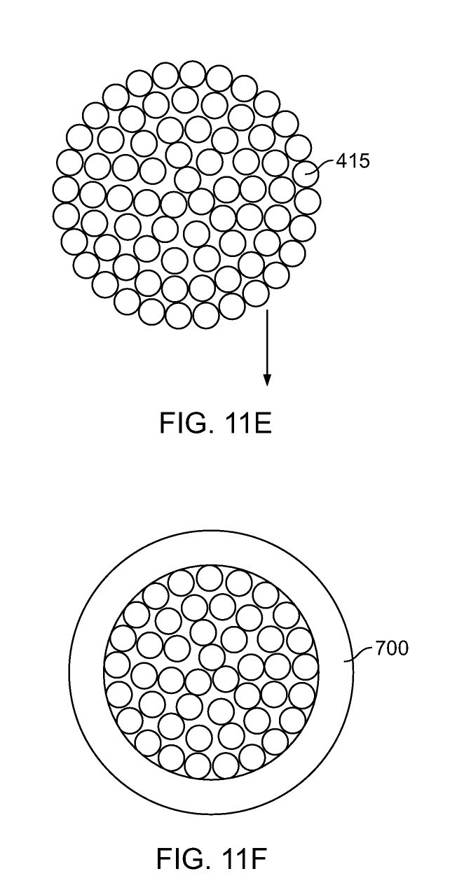

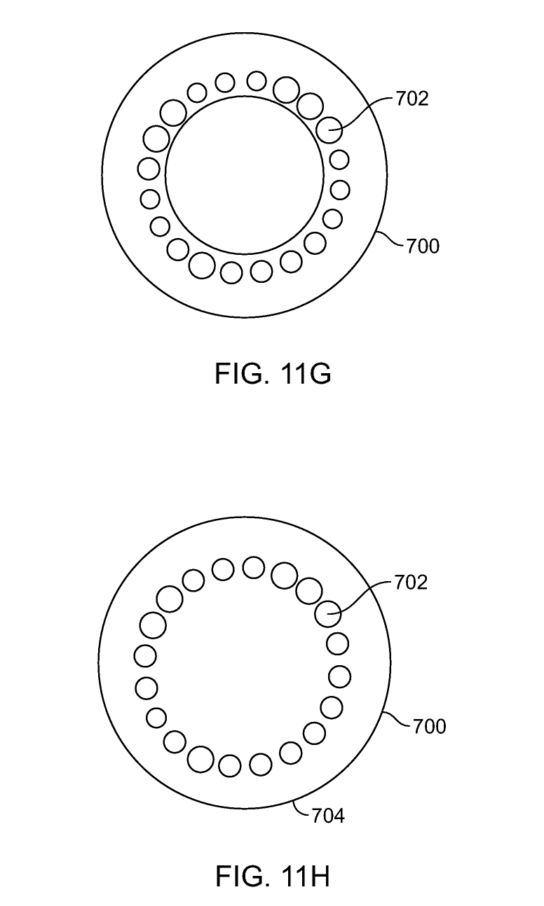

FIGS. 11a to 11b show the progress of the 0°/90° ellipticity or the −45/45° ellipticity depending on the field height x before and after the correction;

FIGS. 11c to 11d show the progress of telecentricity before and after correction;

FIG. 11e to 11g show the influence of the σ setting and the ellipticity with the help of a stop wheel;

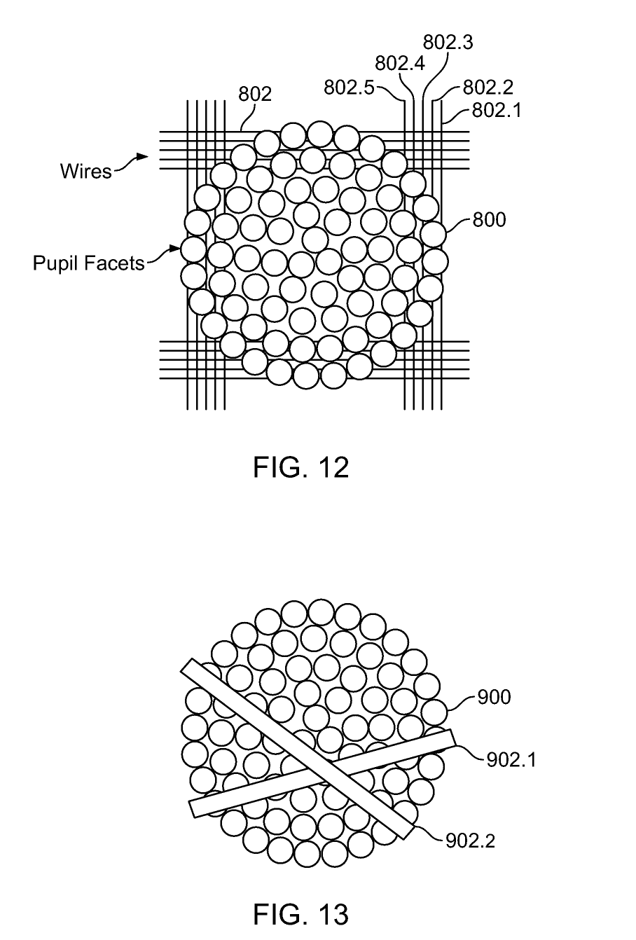

FIG. 12 shows the arrangement with wires for vignetting of individual pupils;

FIG. 13 shows the arrangement of rod-like stops for vignetting individual pupil facets;

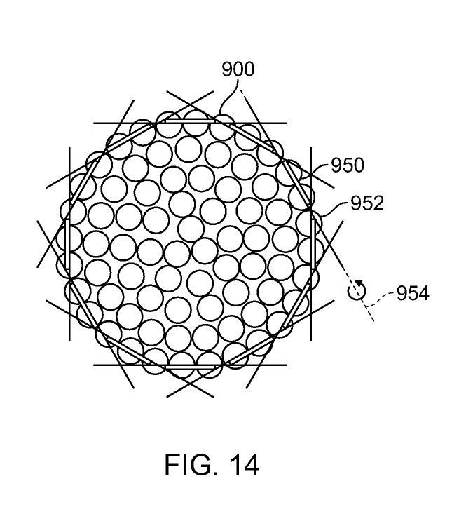

FIG. 14 shows the arrangement of rod-like stops rotatable about an axis for vignetting individual pupil facets;

FIG. 1 shows an elementary diagram of a beam path in an illumination system with two facetted optical elements which is also known as a double-facetted illumination system. The light of a primary light source 1 is collected with the help of a collector 3 and converted into a parallel or convergent light bundle. The parallel or convergent light bundle of the collector illuminates the first facetted optical element 7. The field facets or field raster elements 5 of the first facetted optical element 7 divide the light bundle impinging from the collector onto the first facetted optical element 7 into a plurality of light bundles emerging from each field raster element 5 and generate secondary light sources 10 close to or at the location of a second facetted optical element 11. The plane in which the first facetted optical element lies is designated as first plane 8. In the illustrated example, the second plane 13 in which the second facetted optical element lies and in which the secondary light sources are also formed in this example is a plane conjugated to the exit pupil plane. In the embodiment shown a field optical element 12 projects the secondary light sources 10 into the exit pupil of the illumination system (not shown) which corresponds with the entrance pupil of a subsequent projection objective (not shown). The field raster elements 5 are projected by an optical component comprising the second facetted optical element 11 with pupil raster elements 9 and the field optical element 12 into the field plane 14 of the illumination system This is characteristic for a illumination system with Koehler illumination. By imaging the field raster elements in the field plane in which they are substantially superimposed with the optical component a uniform illumination in the field plane can be reached. A structured mask, the so-called reticle, is preferably arranged in the field plane 14 of the illumination system. The purpose of the field raster elements and the pupil raster elements as shown in FIG. 1 shall be described below with respect to FIGS. 2a and 2b for a first field raster element 20 and a first pupil raster element 22, between which a light channel 21 is formed.

As described before one first field raster element 20 is projected with the help of one first pupil raster element 22 and the field optical component 12 into a field plane 14 of the illumination system in which a field of predetermined geometry and shape is illuminated. The first pupil raster element and the field optical component from the optical component 19, which image the first raster elements in the field plane. A reticle or structured mask is arranged in the field plane 14. Since the field raster element is imaged into the field plane generally, the geometric expansion of the field raster element 20 determines the shape of the illuminated field in the field plane.

An illuminated field in the field plane is shown in FIG. 6.

It can be provided in a first embodiment of the invention that the field raster element 20 has the shape of the field, i.e. in the case of a ring-like field the field raster elements can also have a ring-like shape. This is shown for example in the applications U.S. Pat. No. 6,452,661 or U.S. Pat. No. 6,195,201, the content of which shall be fully included in the present application.

As an alternative to this, the field raster elements can have a rectangular shape. In order to illuminate the bow-like field in the field plane it is necessary in the case of rectangular field raster elements that the rectangular fields are transformed into bow-like fields, e.g. with the help of the field optical element 12, which in case of a reflective system is a field mirror.

A field mirror is not necessary for systems with annular raster elements.

The first field raster element 20 is configured in such a way that an image of the primary light source 1, which is a so-called secondary light source 10, is formed on or close to the place of the first pupil raster element. In order to prevent an excessive heat load on the pupil raster elements 9, the pupil raster elements can be arranged in a defocused manner relative to the secondary light sources.

The secondary light sources have an expansion as a result of the defocusing. The expansion can also be caused by the shape of the light source.

It can be provided for in a preferred embodiment of the invention that the shape of the pupil raster elements is adjusted to the shape of the secondary light sources.

As is shown in FIG. 2b, it is the task of the field optical element 12 to project the secondary light sources 10 into the exit pupil plane 26 of the illumination system, with the exit pupil coinciding with the entrance pupil of the projection objective. Tertiary light sources, so-called sub-pupils, are formed in the exit pupil plane 26 for each secondary light source.

FIG. 3a shows a schematic representation of an embodiment of a reflective microlithography projection exposure system with an illumination system in accordance with the invention, as is used for EUV lithography. The light bundle of the light source 101 is focused by a grazing-incidence collector mirror 103 which in the present case is configured as a nested collector mirror with a plurality of mirror shells, and after spectral filtering with a grating spectral filter element 105 is guided via an intermediate image Z of the light source to the first facetted optical element 102 with field raster elements. The light source 101 of the collector mirrors 103 and the grating spectral filter 105 form a so-called source unit 154. The first facetted optical element with field raster elements divides a light beam impinging onto the first facetted optical element into a plurality of light beams, each light beam producing secondary light sources at the location or close to the location of the second facetted optical element 104 with pupil raster elements. The first facetted optical element 102 is arranged in a first plane 150 and the second facetted optical element 104 is arranged in a second plane 152. Since the light source is usually an extended light source, the secondary light sources are also extended, i.e. that each secondary light source has a predetermined shape. As described above, the individual pupil raster elements can be adjusted to the predetermined shape of the secondary light sources.

The pupil raster elements are used together with a field optical component, a so called field mirror group 121 to project the field raster elements into a field plane 129 of the illumination system in which a structure-bearing mask 114 can be arranged. In the embodiment shown in FIG. 3a the optical component 119 comprises the second facetted optical element 104 and the field mirror group 121.

Since as described above the intensity of the secondary light sources is very high, the second facetted optical element 104 with pupil raster elements is arranged preferably in a defocused manner relative to the secondary light sources. The distance between the and the second plane 152 in which lies the second facetted optical element 104 with the pupil raster elements is approximately 20% of the distance between the first facetted optical element 102 with the field raster elements and the second facetted optical element 104 with pupil raster elements. The distance D between the first facetted optical element 102 and the second facetted optical element 104 is entered in FIG. 3a and is defined along the chief ray CR which extends from the first optical element 102 to the second optical element 104.

In the embodiment shown each field raster element of the first facetted optical element 102 is associated with a pupil raster element of the second facetted optical element 104, as shown in FIGS. 1 to 2b. In a another embodiment of the invention (not shown) the number of pupil raster elements is greater then the number of field raster elements. In such a case the setting of an illumination in the pupil plane can easily changed by changing the association of the field raster elements to the pupil raster elements. In the embodiment shown a light bundle extends between each field raster element and each pupil raster element. The individual light bundles which extend from the field raster element to the pupil raster element are designated as so-called light channel. It is provided for in accordance with the invention that an attenuator 1100 is arranged in at least one of such light channel from a first field raster element to a first pupil raster element. The light bundle extending from the first field raster element to the first pupil raster element has a certain cross section. This cross section is vignetted at least partly by the attenuator. Such an attenuator 1100 in accordance with the invention is shown schematically in FIG. 3a and is arranged in or close to the second plane 152. Close shall mean in the present application that the distance DA from the attenuator 1100 is less than 10% of the physical distance D of the first plane 150 to the second plane 152.

The ellipticity in the exit pupil can be influenced by such an attenuator 1100 in accordance with the invention as described herein.

FIG. 3a further shows the exit pupil plane 140 of the illumination system, which plane coincides with the entrance pupil plane of the projection objective 126. The entrance pupil of the projection objective 126 is obtained from the point of intersection S of the chief ray CR to the central field point Z of the ring field shown in FIG. 6 with the optical axis OA of the projection system 126. The projection system comprises in the illustrated embodiment six mirrors 128.1, 128.2, 128.3, 128.4, 128.5 and 128.6. The structured mask is projected with the help of the projection objective into the image plane 124 in which a light-sensitive object is arranged.

The local x, y, z system of coordinates is shown in the field plane 129 and the local u, v, z system of coordinates is shown in the exit pupil plane 140.

Ellipticity shall be understood in the present application as the weighting of the energy distribution in the exit pupil in the exit pupil plane. When, as is shown in FIG. 3b, a system of coordinates is defined in the u, v, z direction, the energy is distributed in the pupil 1000 over an angular range of the coordinates u, v. The pupil is broken down into angular ranges Q1, Q2, Q3, Q4, Q5, Q6, Q7, Q8 as shown in FIG. 3b. The energy content in the respective angular range is obtained by integration over the respective angular range. I1 for example designates the energy content of angular range Q1. The following therefore applies to I1:

l1=∫E(u,v)dudv Q1

with E(u,v) being the intensity distribution in the pupil.

The following variable is designated as −45/45° ellipticity:

$${E}_{- 45 ° / 45 °} ≡ \frac{I 1 + I 2 + I 5 + I 6}{I 3 + I 4 + I 7 + I 8}$$

and the following variable as 0°/90° ellipticity:

$${E}_{0 ° / 90 °} ≡ \frac{I 1 + I 8 + I 4 + I 5}{I 2 + I 3 + I 6 + I 6}$$

Here I1, I2, I3, I4, I5, I6, I7, I8 are the energy content as defined above in the respective angular ranges Q1, Q2, Q3, Q4, Q5, Q6, Q7, Q8 as illustrated in FIG. 3b.

Since a different exit pupil is obtained for each field point of the illuminated field in the field plane, the pupil and thus the ellipticity is dependent on the position in the field. An annular field as used in microlithography is shown in FIG. 6. The field is described by an x, y, z system of coordinates in the field plane 129. Since the pupil is dependent upon the field point, it is dependent upon the x, y position in the field.

Furthermore, the illumination system as illustrated in FIG. 3a also comprises a further attenuator 1000 which, as described in WO2005/015314, is arranged in or close to the first plane 150 in which the first facetted optical element 102 is arranged. As a result of the attenuator 1000, individual field facets can be vignetted partly or completely and thus the uniformity of the illumination in the field plane can be influenced in a purposeful manner. The further attenuator 1000 is optional, but not necessary for the invention.

FIG. 4 shows a two-dimensional arrangement of field raster elements or field facets 309 on a first facetted optical element designated in FIG. 3a with reference numeral 102, a so-called field honeycomb plate. The distance between the field raster elements 309 is chosen as small as possible. FIG. 4 shows a first facetted optical element with a number of 122 field raster elements 309 arranged thereon. The circle 339 designates the illumination boundary of a circular illumination of the first optical element with field raster elements 309. Such an illumination is provided e.g. by a collector arranged in the light path from the light source to the first facetted optical element before the first facetted optical element. The substantially rectangular field raster elements 309 have a length for example X_{FRE}=43.0 mm and a width Y_{FRE}=4.0 mm. All field raster elements 309 are arranged within the circle 339 and therefore are illuminated completely.

FIG. 5 shows a first arrangement of pupil raster elements 415 on the second facetted optical element which is designated in FIG. 3a with reference numeral 104. The pupil raster elements 415 are arranged in a point-symmetric way to the center of a u, v, z system of coordinates. The shape of the pupil raster elements 415 preferably corresponds to the shape of the secondary light sources in the plane in which the second optical element with pupil raster elements is arranged. In the embodiment shown the number of pupil facets or pupil raster elements 415 correspond to the number of field raster element, i.e. if the system comprises 122 field facets or field raster elements 309, then the system comprises 122 pupil facets or pupil raster elements.

FIG. 6 shows an annular field as is formed in the field plane 129 by the illumination system according to FIG. 3a.

Field 131 has an annular shape. FIG. 6 shows the system of coordinates and the central field point Z of the field 131 and an x, y system of coordinates. The y-direction designates the so-called scanning direction when the illumination system is used in a scanning microlithography projection system and the x-direction designates the direct which is perpendicular to the scanning direction. Depending on the x-position, which is also designated as the so-called field height, scan-integrated variables can be determined, i.e. variables which are integrated along the y-axis, i.e. in scanning direction. Many variables of an illumination are field-dependent variables. Such a field-dependent variable is for example the so-called scanning energy (SE), whose amount varies depending on the field height x, i.e. the scanning energy is a function of the field height. The following applies generally:

SE(x)=∫E(x,y)dy,

with E being the intensity distribution in the x, y field plane depending on x and y. It is advantageous for a uniform, i.e. even illumination and other characteristic variables of the illumination system such as ellipticity and telecentricity which also depend on the field height x when such variables have a substantially equal value substantially over the entire field height x and there are only slight deviations.

Ellipticity shall be understood in the present application as the weighting of the energy distribution in the pupil associated with the respective field point in the exit pupil plane. Reference is hereby made to FIG. 3b with the relevant description.

A principal ray of a light bundle is defined further in each field point of the illuminated field. The principal ray is the energy-weighted direction of the light bundle starting from a field point.

The deviation of the principal ray from the chief ray CR is the so-called telecentric error. The following applies to the telecentric error:

$$\vec{s} ( x , y ) ≡ \frac{1}{N} \int d u d v ( \frac{u}{v} ) E ( u , v , x , y )$$

with N normalizing the vector s(x,y) which indicates the direction of the principal ray. E(u,v,x,y) is the energy distribution depending on the field coordinates x,y in the field plane 129 and the pupil coordinates u,v in the exit pupil plane 140.

Generally, each field point of a field in the field plane 129 is associated with an exit pupil in the exit pupil plane 140 of the illumination system according to FIG. 3a. A plurality of tertiary light sources which are also designated as sub-pupils are formed in the exit pupil associated with the respective field point.

FIG. 7 shows a scan-integrated pupil for a field height of x=−52 mm of an annular field, as shown in FIG. 6.

The scan-integrated pupil is obtained by the integration over the energy distribution E(u,v,x,y) along the scanning path, i.e. along the y-direction. The scan-integrated pupil is thus:

E(u,v,x)=∫dyE(u,v,x,y)

Integration over the coordinates u,v of the scan-integrated pupil then produces the intensities I1, I2, I3, I4, I5, I6, I7, I8 as defined above and thus the −45°/45° or 0°/90° ellipticity depending on the field height x, e.g. of x=−52 mm.

As is shown in FIG. 7, the exit pupil in the exit pupil plane comprises individual sub-pupils, namely tertiary light sources 500. As is shown in FIG. 7, the individual sub-pupils 500 contain different energies and have a fine structure originating from the collector shells or collector spokes of a nested collector for example, e.g. the nested collector 103 as shown in FIG. 3a. The different intensity values of the sub-pupils 500 are the consequence of an inhomogeneous illumination of the first optical element 102. In addition to the energetic imbalance of the individual sub-pupils 500 there is also a geometric imbalance. As is clearly shown in FIG. 7, a number of sub-pupils 500 have elliptic shapes, whereas others are provided with a nearly circular configuration. Both the geometric difference in the shape of the individual sub-pupils as well as the energetic difference ensure that ellipticity (e.g. the −45°/45° or 0°/90° ellipticity) varies strongly in the exit pupil depending on the field height, i.e. along the x-coordinate.

As already mentioned above, a possible even or uniform ellipticity is desirable over the field height, i.e. along the x-coordinate.

This can be achieved in accordance with the invention in such a way that individual sub-pupils 500 are vignetted partly or completely in the exit pupil with the help of an attenuator which is arranged on or close to the second plane 152 or a plane conjugated thereto.

Ellipticity can be influenced in a purposeful manner by attenuating the light intensity of a light bundle with the help of stops or filters which are associated with an individual pupil facet or an individual pupil raster element. The attenuator can be a stop for example with which a single pupil facet or a single pupil raster element is vignetted partly or completely.

FIG. 8 shows a scan-integrated pupil E(u,v,x)=∫dyE(u,v,x,y) to the field height x=0 mm, i.e. along a scanning path which includes the central field point Z according to FIG. 6. The so-called 0 degree/90 degree ellipticity is obtained as described above in connection with FIG. 3b. For the correction of ellipticity of 0 degree/90 degree ellipticity, sub-pupils are vignetted, as shown in FIG. 8. The vignetted sub-pupils are designated in FIG. 8 with reference numeral 502. The non-vignetted sub-pupils are designated with reference numeral 500.

FIG. 9 shows the pupil facets or pupil raster elements of the second optical facetted element. The pupil facets are designated with reference numeral 415, as in FIG. 5. FIG. 9 further shows the stops 420.1, 420.2, 420.3, 420.4, 420.5, 420.6, with which the pupil facets are partly vignetted in order to remove, as demanded above, energy from certain areas of the exit pupil. The recesses for non-vignetted pupil facets are designated with reference numeral 440.

FIGS. 10a to 10c show possible types of stops for vignetting individual pupil facets. FIG. 10a shows a ring stop 600, FIG. 10b a rectangular stop 602 and FIG. 10c a so-called trapezoid stop 604. Depending on the type of stop, the energy of the sub-pupil associated with the pupil facet 415 is reduced by the stop in the exit pupil of the illumination system and the focus of the energy distribution in the sub-pupil is displaced.

The ring stop 600 has the advantage that it is relatively easy to construct and can be used in a compact manner.

The advantage of the other types of stops (e.g. the rectangular stop 602) is that it is easier to readjust. A rectangular stop 602 or a trapezoid stop 604 can be introduced from the outside into the beam path, with the depth of the introduction being variable. In contrast to this, a stop wheel consisting of fixed ring stops can no longer be changed. Changeable ring field stops in the form of iris stops are possible, but can only be produced with a high amount of effort due to the required precision.

It is especially advantageous when the stop for vignetting individual pupil facets is integrally made. This stop can be arranged on the cooling ring of the second facetted optical element, i.e. the pupil facet mirror.

Such a stop wheel is shown in FIG. 9. The partial vignetting of the individual pupil facets occurs in a stop according to FIG. 9 in such a way that recesses are arranged in the stop wheel which have the same shape.

In the embodiment in accordance with FIG. 9, the individual openings 420.1, 420.2, 420.3, 420.4, 420.5, 420.6, 420.7, 420.8, 420.9, 440 are circular openings in the stop which are especially characterized by the ease with which they can be produced.

With the help of the stop as shown in FIG. 9 it is possible to vignette individual pupil facets in full or in part. The effect of introducing the stop into the course of the ellipticity depending on the field height, i.e. the x-coordinate, is shown for the −45°/45° or 0°/90° ellipticity in the FIGS. 11a and 11b. FIG. 11a shows the −45°/45° ellipticity 2000.1 or the 0°/90° ellipticity 2000.2 for an illumination system according to FIG. 3a without a stop close to the second facetted element. Depending on the field height, the −45°/45° ellipticity fluctuates between 100% and 116% and the 0790° ellipticity between 100% and 92%. Ellipticity is strongly improved by introducing a stop as shown in FIG. 9 into the beam path of the illumination system close to the second facetted optical element. This is shown in FIG. 11b. Depending on the field height, the −45°/45° ellipticity 2000.1 fluctuates between 100% and 104% and the 0°/90° ellipticity between 97.8% and 100%. FIGS. 11c and 11d show the telecentric error of the system depending on the field height x for a system according to FIG. 3a with and without an attenuator before the second facetted optical element. FIG. 11c shows the progress of the telecentric error for a system according to FIG. 3a without attenuator. The telecentric error is more than 0.5 mrad in the x-direction 2100.1 and in the y-direction 2100.2. By introducing the attenuator before the second facetted optical element, the telecentric error according to FIG. 11d can be kept smaller than 0.5 mrad for the x-direction 2102.1 and the y-direction 2102.2.

A further advantage in using the stop wheel is that the stop wheel can also be used for the setting, especially the σ-setting. This is shown in FIGS. 11e to 11h. FIG. 11e shows by way of example a second facetted optical element with pupil facets 415. By introducing a stop as shown in FIG. 11f it is possible to vignette the pupil facets completely at the edge 700 and to thus set the σ-setting. In order to make an ellipticity correction it can be provided that the closest situated pupil facets 702 are partly vignetted with a stop wheel as shown in FIG. 11g. It is thus possible with a stop wheel as shown in FIGS. 11g and 11h close to the second facetted optical element to make a setting of the σ-setting in addition to a correction of the ellipticity. The σ-setting defines an annular illumination in the pupil. The following applies generally for an σ-value of a setting:

σ=σ_{EIN}/σ_{OUT}

with the σ-value describing the filling of the objective pupil. At a value of σ=1.0, the objective pupil is fully filled. At a value of σ=0.6, the pupil is only partly filled. Reference is hereby made to U.S. Pat. No. 6,658,084 B2 concerning the definition of the σ-value.

FIG. 11 h gives another example of a stop wheel. In the example shown in FIG. 11 h the pupil facets at the edge 700 and in the middle 704 are fully vignetted, whereas the pupil facets in the ring shape area 702 are only partly vignetting providing a ring shaped illumination in this area.

FIGS. 12 to 13 show other alternatives for vignetting individual pupil facets 800. In the embodiment according to FIG. 12, the wires 802 are used in a purposeful way for light vignetting of individual sub-pupils. In order to achieve a variable control of the vignetting it is provided that the individual wires are displaceable in their position along the directions 802.1, 802.2, 802.3, 802.4 for example.

FIG. 13 shows a variable vignetting of pupil facets 900 by stops. The stops are marked with reference numerals 902.1, 902.2.

When a variable vignetting of pupil facets 900 is to be achieved with the help of stops, it can be provided for in an embodiment that the stops 950 are arranged on wires 952 which are rotatable for example about an axis 954, as shown in FIG. 14. Depending on the setting about the axis 954, the stop 950 can cover the pupil facets with its narrow side or its broad side, so that different vignetting is obtained depending on the rotation about the axis 954.

An illumination system is thus provided for the first time with the present invention with which scan-integrated ellipticity errors and telecentric errors can be corrected sufficiently by switching off individual pupil facets.

Further advantages of introducing attenuators, especially stops close to the plane in which the second facetted element is arranged or a conjugated stop in connection with the same are the possibility of subsequent correcting in case of changes in the illumination system. Such changes can occur by the exchange of the light source, e.g. the plasma source, or the entire source/collector unit.

Furthermore, changing system properties as a result of the operation of the illumination system can be compensated. For example, the mirror coatings degrade, leading to a change in the reflectivity properties of the mirrors. This requires a subsequent correction for the entire system.

Furthermore, the use of fixed and variable stops allows the correction of production-induced faults in mirror coatings for example or in the case of adjusting problems.

A further important application of the stops is the variation of the setting G. For example, a setting can be reduced by a complete masking out of the outer pupil facet ring. This can be combined with a renewed ellipticity correction for the newly set δ-setting.

1. An illumination system configured to illuminate an object in a field plane with radiation from a light source, the illumination system comprising:
a first facetted optical element in a first plane comprising at least a first field raster element and second field raster element, the first and second field raster elements being configured to receive light from the light source during operation of the illumination system and divide the light into a first bundle of light and a second bundle of light;
an optical component comprising at least a second facetted optical element in a second plane, the second facetted optical element comprising a first pupil raster element and a second pupil raster element; and
an attenuator arranged in or close to the second plane or a plane conjugated to the second plane, the attenuator being arranged at least in a path of the first light bundle between the first field raster element and the first pupil raster elements,
wherein during operation of the illumination system the light source emits radiation having a wavelength of 193 nm or less, the first light bundle impinges upon the first pupil raster element and the second light bundle impinges upon the second pupil raster element, the optical component images the first and second field raster elements to the field plane, and the object is scanned in a scanning direction in the field plane where the attenuator is arranged such that a scan-integrated ellipticity at the field plane varies by less than ±10% in a direction perpendicular to the scanning direction.

2. The illumination system according to claim 1, wherein the first facetted optical element comprises more than 20 field raster elements.

3. The illumination system according to claim 1, wherein the second facetted optical element comprises more than 20 pupil raster elements.

4. The illumination system according to claim 1, further comprising a collector positioned in a light path between the light source and the first facetted optical element, the collector being configured so that during operation of the illumination system the collector collects radiation from the light source and illuminates an area on the first facetted optical element is arranged before the first facetted optical element.

5. The illumination system according to claim 1, wherein the attenuator is positioned at a physical distance, DA, along a light path from the first facetted optical element to the second facetted optical element to the second plane or the plane conjugated to the second plane, wherein DA is smaller than 10% of a physical distance (D) between the first plane to the second plane.

6. The illumination system according to claim 1, wherein during operation of the system the first light bundle has a first cross section and the attenuator vignettes at least a first area of the cross section of the first light bundle.

7. The illumination system according to claim 1, wherein the attenuator is a stop.

8. The illumination system according to claim 7, wherein the stop is a ring stop or a rectangular stop or a trapezoid stop.

9. The illumination system according to claim 7, wherein the stop is part of a stop wheel.

10. The illumination system according to claim 7, wherein the stop comprises at least one wire.

11. The illumination system according to claim 1, wherein the attenuator comprises an apparatus configured to variably vignette at least the cross section of the first light bundle.

12. The illumination system according to claim 11, wherein the apparatus comprises wires with elements swivelable configured to swivel about a rotation axis wherein the elements vignette different areas of the cross section of the first light bundle depending on their position.

13. The illumination system according to claim 1, wherein the attenuator is a filter element.

14. The illumination system according to claim 1, wherein at least the first and second field raster element are reflective.

15. The illumination system according to claim 1, further comprising a second attenuator arranged in the light path from the light source to the first optical element in or close to the first plane or a plane which is conjugated to the first plane.

16. The illumination system according to claim 15, wherein the second attenuator is positioned at a physical distance along the light path from the light source to the first facetted optical element which is smaller than 10% of a physical distance of the first plane to the second plane.

17. The illumination system according to claim 1, wherein the first and the second pupil raster element are reflective.

18. The illumination system according to claim 1, wherein the first and second pupil raster element have a different shape.

19. The illumination system according to claim 1, wherein during operation the system is configured to illuminate a field in the field plane, wherein the field has a shape.

20. The illumination system according to claim 19, wherein the first and the second field raster elements have the shape of the field.

21. The illumination system according to claim 1, further comprising at least one field-forming mirror, wherein the field-forming mirror is arranged in the light path between the second facetted optical element and the field plane.

22. A projection exposure system for microlithography comprising:
the illumination system according to claim 1; and
a projection objective configured to project the object in the field plane to an image in an image plane.

23. The projection exposure system according to claim 22, wherein the object is a structured mask.

24. The projection exposure system according to claim 23, wherein a light-sensitive object is arranged in the image plane.

25. A method for producing a microstructured component by use of a projection exposure system according to claim 22, comprising:
illuminating a structured mask arranged in the field plane;
projecting the structured mask to a light-sensitive layer using the projection objective;
developing the light-sensitive layer
forming the microstructured component or a part of a microstructured component using the developed light-sensitive layer.

26. The illumination system according to claim 1, wherein the first facetted optical element comprises more than 40 field raster elements.

27. The illumination system according to claim 1, wherein the first facetted optical element comprises more than 100 field raster elements.

28. The illumination system according to claim 1, wherein the first facetted optical element comprises more than 300 field raster elements.

29. The illumination system according to claim 1, wherein the second facetted optical element comprises more than 40 field raster elements.

30. The illumination system according to claim 1, wherein the second facetted optical element comprises more than 100 field raster elements.

31. The illumination system according to claim 1, wherein the first facetted optical element comprises more than 300 field raster elements.

32. The illumination system according to claim 1, wherein the optical component images the first and second field raster element to a field in the field plane such that a telecentricity error at the field plane does not exceed ±0.5 mrad across the field in a direction perpendicular to the scanning direction.

33. An illumination system configured to illuminate an object in a field plane with radiation from a light source, the illumination system comprising:
a first facetted optical element in a first plane comprising at least a first field raster element and a second field raster element, the first and second field raster elements being configured to receive light from the light source during operation of the system and divide the received light into a first bundle of light and a second bundle of light;
an optical component comprising at least a second facetted optical element in a second plane, the second facetted optical element comprising a first pupil raster element and a second pupil raster element;
an attenuator arranged in or close to the second plane or a plane conjugated to the second plane, the attenuator being arranged at least in a path of the first light bundle between the first field raster element and the first pupil raster element,
wherein during operation of the illumination system the light source emits radiation having a wavelength of 193 nm or less, the first light bundle impinges upon the first pupil raster element and the second light bundle impinges upon the second pupil raster element, the optical component images the first and second field raster elements to the field plane, and the first light bundle has a first cross section and the attenuator vignettes at least a first area of the first cross section of the first light bundle.

34. The illumination system according to claim 33, wherein the attenuator is a stop.

35. The illumination system according to claim 34, wherein the stop is a ring stop or a rectangular stop or a trapezoid stop.

36. The illumination system according to claim 34, wherein the stop is part of a stop wheel.

37. The illumination system according to claim 34, wherein the stop comprises at least one wire.

38. The illumination system according to claim 33, wherein the attenuator comprises an apparatus configured to variably vignette at least the cross section of the first light bundle.

39. The illumination system according to claim 33, wherein the apparatus comprises wires with elements configured to swivel about a rotation axis, wherein the elements vignette different areas of the cross section of the first light bundle depending on their position.

40. An illumination system configured to illuminate an object in a field plane with radiation from a light source, the illumination system comprising:
a first facetted optical element in a first plane comprising at least a first field raster element and a second field raster element, the first and second field raster elements being configured to receive light from the light source during operation of the system and divide the received light into a first bundle of light and a second bundle of light;
an optical component comprising at least a second facetted optical element in a second plane, the second facetted optical element comprising a first pupil raster element and a second pupil raster element;
an attenuator arranged in or close to the second plane or a plane conjugated to the second plane, the attenuator being arranged at least in a path of the first light bundle between the first field raster element and the first pupil raster element,
wherein during operation of the illumination system the light source emits radiation having a wavelength of 193 nm or less, the first light bundle impinges upon the first pupil raster element and the second light bundle impinges upon the second pupil raster element, the object is scanned in a scanning direction in the field plane, and the optical component images the first and second field raster elements to a field in the field plane such that a telecentricity error at the field plane does not exceed ±0.5 mrad across the field in a direction perpendicular to the scanning direction.
